(19) United States
(12) Patent Application Publication
(10) Pub. No.: US 2026/0063120 A1
(43) Pub. Date: Mar. 5, 2026

(54) OPERATING STRATEGY FOR LIMITING THE POWER CONSUMPTION OF A BRUSHLESS MOTOR FOR ELECTRICALLY DRIVEN PASSENGER-CAR AIR-SPRING COMPRESSORS THROUGH MODE SWITCHING

(71) Applicant: ZF CV Systems Europe BV, Brussels (BE)

(72) Inventors: Uwe Stabenow, Laatzen (DE); Jörg Meier, Hessisch Oldendorf (DE); Dirk Kirchhoff, Gronau/Leine (DE); Marco Seeger, Langenhagen (DE)

(21) Appl. No.: 19/384,648

(22) Filed: Nov. 10, 2025

Related U.S. Application Data
(63) Continuation of application No. PCT/EP2024/061315, filed on Apr. 24, 2024.

(30) Foreign Application Priority Data
May 9, 2023 (DE) 10 2023 112 177.4

(51) Int. Cl. F04B 49/22; B60R 16/023; F04B 49/06; H02P 6/28

(52) U.S. Cl. CPC F04B 49/22; B60R 16/023; F04B 49/06; H02P 6/28; F04B 2205/03; F04B 2205/04; H02P 2207/05

(57) ABSTRACT

A compressed-air supply system includes at least one compressed-air consumer, compressed-air lines, electrically controllable valves, a compressed-air controller for actuating the valves, a compressor having an electric motor as a drive, and a pressure reservoir. The compressed-air consumer can be pneumatically connected to the compressor and/or the pressure reservoir via the lines and the valves such that the compressed-air supply system can be operated either in an open or in a closed operating mode. The controller has an input for a current signal, which represents a motor current drawn or to be drawn by the electric motor. The controller is configured to actuate the valves in accordance with the open operating mode when a current signal is present at the current signal input, the current signal representing a mean motor current, the magnitude of which is equal to or greater than a maximum value for the motor current.

### CROSS-REFERENCE TO RELATED APPLICATIONS

This application is a continuation application of international patent application PCT/EP2024/061315, filed Apr. 24, 2024 designating the United States and claiming priority from German application 10 2023 112 177.4, filed May 9, 2023, and the entire content of both applications is incorporated herein by reference.

### TECHNICAL FIELD

The disclosure relates to a compressed-air supply system for a vehicle. The disclosure also relates to a method for operating a compressed-air supply system of this kind.

### BACKGROUND

In motor vehicles, compressed-air supply systems can supply compressed air to, for example, an air spring system as a compressed-air consumer and/or a pneumatic brake system as a compressed-air consumer. In order to be able to supply compressed qair at a sufficiently high pressure for compressed-air consumers of this kind, compressing devices or compressors are required for generating compressed air. Compressing devices or compressors of this kind are typically driven by electric motors which draw a motor current during operation. Compressing devices or compressors are used as synonyms in the present description and refer to assemblies which compress air.

Essential components of a compressed-air supply system, in addition to the compressed-air consumer or the compressed-air consumers and the compressor or compressing device and its drive, are electrically controllable valves which can be controlled—that is, for example opened or closed—by a compressed-air controller. In this way, compressed air can be supplied to the individual compressed-air consumers of a compressed-air supply system in a targeted manner or else compressed air can be discharged. Depending on which compressed-air consumers have to be supplied with compressed air during the particular operating situation, the compressor work to be performed by the compressor can vary greatly. As explained in further detail below, the torque to be delivered by the drive of the compressor or compressing device depends on the pressure that the compressed air has to be at for the particular operating situation. If the compressor or compressing device is driven by an electric motor, the current consumption by the electric motor depends on the torque to be delivered (that is, the operating load of the drive) at the supply voltage typically provided by the on-board electrical system of a vehicle.

The compressing device or compressor and the associated drive, in particular the associated electric motor, are preferably combined in one structural unit—referred to as compressor module below. Compressor modules are used, for example, for compressed-air supply systems of motor vehicles.

Electric motors used for driving compressors or compressing devices are preferably brushless direct-current motors (BLDC motors: brushless direct-current motors). A brushless direct-current motor, as a so-called internal rotor motor, typically has a fitted with electromagnetic coils—that is to a coil-wound, a rotor fitted with permanent magnets, and a motor controller. The motor controller is configured as an electronic commutator in such a way that the motor controller controls the current supply to the coils of the s (also referred to as coils below) via circuit breakers such that the coils are in turn periodically supplied with current in such a way that a rotating magnetic field is produced, this causing synchronous rotation of the rotor fitted with permanent magnets due to magnetic forces. Brushless direct-current motors of this kind with rotors fitted with permanent magnets are therefore also referred to as PMSM motors, where PMSM stands for permanent magnet synchronous motor. The abbreviation PMSM is typically used for sine-commutated brushless electric motors, while the abbreviation BLDC (brushless direct-current) is usually used for block-commutated brushless electric motors. In block commutation, the energization of the (for example three or n times three) coils is digitally switched over, that is, either no current or full current is applied to the windings of the respective coil or coils of a phase. In sine commutation, each coil of the motor is energized with a sine curve offset by 120°, this resulting in a continuously rotating magnetic field of constant strength.

For speed control known per se of a brushless electric motor, the electric motor has means for rotor angle detection which have electronic sensors, such as Hall sensors for example, for detecting the rotor position. This also allows a phase angle between the applied rotating field and the mechanical rotation of the rotor to be detected and the phase angle of the rotating field to be correspondingly adjusted. BLDC motors therefore behave similarly to mechanically commutated direct-current motors. However, brushless direct-current motors are more efficient and subject to less wear and their speed can be controlled better than electric motors with a brush commutator.

In compressor modules for generating compressed air in a compressed-air supply system, for example for motor vehicles, the compressor generating the compressed air and its electric motor serving as a drive form one structural unit. For both efficient and environmentally friendly operation, the configuration and operation of the electric motor—for example the brushless direct-current motor—pose a particular challenge. This includes, amongst other things, the compressor module being able to provide a sufficient amount of compressed air in the respective compressed-air supply system at any time in the various possible operating situations—even the rare ones. This means that a compressor module has to provide a sufficient amount of compressed air for the compressed-air supply system even under unfavorable conditions that occur only rarely (worst-case operating situation). For this purpose, the drive, that is, the preferably brushless direct-current motor for example, also has to be configured in a corresponding manner. At a given supply voltage of the electric motor, a higher mechanical load—that is, a higher mechanical output power—inevitably leads to a greater current consumption by the electric motor. However, in order to protect the on-board electrical system of a motor vehicle, the maximum current consumption by a direct-current motor has to be limited.

WO 2020/225024 A1 discloses operating a BLDC motor for driving a compressor at a constant speed and reducing this speed depending on the load conditions operating voltage and load (torque) in order to avoid overdimensioning the motor.

### SUMMARY

It is an object of the disclosure to ensure reliable and environmentally friendly operation of a compressor module in the simplest possible way.

According to an embodiment, the disclosure proposes a compressed-air supply system, in particular for a motor vehicle, in order to achieve this object, the compressed-air supply system having at least the following components:
one or more compressed-air consumers, compressed-air lines, electrically controllable valves, a compressed-air controller for actuating the electrically controllable valves, a compressor or compressing device having an electric motor as a drive, and a pressure reservoir.

The compressed-air consumer or consumers is/are or can be pneumatically connected to the compressor or compressing device and/or the pressure reservoir via the compressed-air lines and the electrically controllable valves in such a way that the compressed-air supply system can be operated either in an open operating mode or in a closed operating mode.

In the closed operating mode, compressed air from the pressure reservoir is fed to the compressed-air consumer or consumers or compressed air from the compressed-air consumer is fed to the pressure reservoir, in each case with the aid of the compressor or compressing device. For this purpose, the electrically controllable valves and the compressor or compressing device are actuated by the compressed-air controller in accordance with the closed operating mode. In the open operating mode, compressed air is fed from the surrounding area to the compressed-air consumer or consumers or the pressure reservoir via the compressor or compressing device. For this purpose, the electrically controllable valves are actuated by the compressed-air controller in accordance with the open operating mode.

According to the disclosure, the compressed-air controller has a current signal input for a current signal, which represents a motor current drawn or to be drawn by the electric motor driving the compressor or compressing device. The compressed-air controller is configured to actuate the electrically controllable valves in accordance with the open operating mode of the compressed-air supply system when a current signal is present at the current signal input, the current signal representing a mean motor current, the magnitude of which is equal to or greater than a specified maximum value for the motor current. The criterion for switching over the operating mode is preferably not the instantaneous value of the motor current, but rather a mean motor current, which represents the short-term average value of the motor current, so that switchover of the operating mode is not already triggered by a short-term current peak or cyclical fluctuations in the instantaneous value of the motor current. The value for the mean motor current can be formed, for example, by the motor controller by way of the motor controller measuring the, for example, three phase currents and then calculating the mean current consumption of the electric motor therefrom.

The disclosure allows the electric motor to be configured for a constant speed as standard. According to the disclosure, the necessary drive power of the compressor or compressing device is reduced by switching over from the closed to the open operating mode when the permissible current consumption is exceeded. For this purpose, the current, time-averaged or low-pass-filtered current consumption by the electric motor for driving the compressor or compressing device is determined, and when the defined limit value is exceeded closed operation of the compressed-air supply system is terminated and control is completed in the open operating mode.

Mode switchover based on the mean motor current has the advantage of the assembly-specific tolerances, the different pressure ranges and other values that influence the current not having to be stored in the form of worst-case assumptions, but rather the performance of the compressor being maximized in all operating ranges.

In addition, the disclosure allows the speed of the compressor together with the drive to be kept constant since, when the maximum permissible motor current Iₘₐₓ is exceeded, there is no reduction in speed but rather a reduction in the load due to mode switchover.

The current signal input is preferably connected to at least one current sensor, which is configured to detect a motor current I_{B} drawn by the electric motor driving the compressor or compressing device and to output a signal representative of this motor current to the compressed-air controller. The current sensors used may be the current sensors of the motor controller that are usually provided for each phase. A mean motor current can already be formed by a motor controller on the compressor module or by the compressed-air controller. For example, the motor controller can determine the mean motor current from the three measured phase currents. As an alternative, an additional current sensor could also be provided.

In an embodiment, the compressed-air consumer is an air spring system of a vehicle, which has one or more bellows.

The compressor or compressing device is preferably combined with the electric motor in the form of a compressor module to form one structural unit and thus these are firstly optimally coordinated with each other and secondly can be easily integrated into a compressed-air supply system as a unit.

The electric motor is preferably a speed-controlled BLDC motor, for which at least one target speed is specified during operation.

In particular with regard to discharging air from the compressed-air consumer, for example when lowering a vehicle with an air spring system, it is advantageous when the compressed-air controller is configured to predictively determine a mean motor current to be drawn by the electric motor on the basis of an air pressure in the compressed-air supply system and a request—in particular a “Lower” request—to the compressed-air consumer. When the predictively determined mean motor current reaches or exceeds the defined maximum value for the motor current at the specified speed, the motor speed is defined in the first step in such a way that the permissible current cannot be reached or exceeded. From an acoustic point of view in particular, the fact that the entire lowering process can thus be carried out without further speed adjustment is advantageous here. If defining this speed results in a value that is too low in the first step, the lowering process is started with open operation as a second step. It is advantageous here to avoid switching over from closed to open operation during the current lowering process since this switchover requires activation of several valves. The associated noticeable delay in the lowering process is reliably avoided with this procedure.

In the event of a “Lift” request—that is, when compressed air has to be fed to the compressed-air consumer, switchover from the closed to the open operating mode can be performed simply by closing (deactivating) a boost valve.

The compressed-air supply system preferably has a pressure sensor, which is arranged and configured such that, during operation, it detects an air pressure prevailing in the compressed-air supply system and outputs a pressure signal representative of this air pressure to the compressed-air controller. On the basis of the pressure signal and a request signal, the compressed-air controller can predictively determine the required motor current and compare it with the specified maximum motor current Iₘₐₓ in order to optionally adjust the speed or switch over the mode.

The compressed-air supply system preferably has a reservoir valve, which is pneumatically arranged between the pressure reservoir and a pneumatic main pressure line.

It is also advantageous if the compressed-air supply system has a boost valve, which is pneumatically arranged between the pressure reservoir and a boost and return flow line.

A further aspect relates to various methods according to the disclosure. A method is used for operating a compressed-air supply system, in particular for a motor vehicle, including:
one or more compressed-air consumers, compressed-air lines, electrically controllable valves, a compressed-air controller for actuating the electrically controllable valves, a compressor or compressing device having an electric motor as a drive, and a pressure reservoir.

From amongst these, the compressed-air consumer or consumers is/are or can be pneumatically connected to the compressor or compressing device and/or the pressure reservoir via the compressed-air lines and the electrically controllable valves in such a way that the compressed-air supply system can be operated either in an open operating mode or in a closed operating mode.

According to a method, a current signal, which represents a motor current drawn or to be drawn by the electric motor driving the compressor or compressing device, is fed to the compressed-air controller during operation. The compressed-air controller switches over the compressed-air supply system from the closed to the open operating mode and actuates the electrically controllable valves in accordance with the open operating mode of the compressed-air supply system when a current signal is present at the current signal input, the current signal representing a mean motor current I_{B}, the magnitude of which is equal to or greater than a specified maximum value Iₘₐₓ for the motor current. The mean motor current is a value of the motor current averaged over a period of a few tenths of a second and/or low-pass filtered. Forming a short-term average value of the motor current I_{B} or low-pass filtering the motor current prevents short-term peak values of the motor current from already leading to a switchover in mode.

Switchover from the closed operating mode to the open operating mode is preferably performed when compressed air is fed to the pressure consumer by deactivating the boost valve. For this purpose, the compressed-air supply system has a boost valve, which is pneumatically connected to the pressure reservoir.

According to a first advantageous variant, the switchover from the closed operating mode to the open operating mode is performed when compressed air is intended to be discharged from the pressure consumer by switching off the compressor, closing (deactivating) the return flow valve and the reservoir valve and opening (activating) the outlet valve. For this purpose, the compressed-air supply system has an outlet valve, a return flow valve and a reservoir valve, which is pneumatically connected to the pressure reservoir.

Since the mean motor current is proportional to the drive torque respectively required by the compressor (torque requirement), the open operating mode or the closed operating mode and/or a suitable target speed can also be selected by predictive control entirely without taking into account the motor current itself but rather solely on the basis of the influencing variables influencing the torque requirement of the compressor at a given speed and their foreseeable temporal development—for example the counterpressure which increases as the pressure reservoir fills up. This—the predictive selection of the open or closed operating mode and the corresponding actuation of the compressed-air supply system—represents an independent inventive concept, which can be realized both in combination with the mode switchover described here on the basis of the motor current and also independently of the motor current. The method variants outlined below can therefore also be realized independently of the method outlined above.

According to a first advantageous variant, the compressed-air controller, when compressed air is to be discharged from the pressure consumer, activates the closed operating mode if the pressure in the pressure reservoir is less than a specified or learnt reservoir pressure limit value or the open operating mode if the pressure in the pressure reservoir is higher than a specified or learnt reservoir pressure limit value. For this purpose, the compressed-air supply system has a pressure sensor at the compressed-air reservoir and also an outlet valve, a return flow valve and a reservoir valve, which is pneumatically connected to the pressure reservoir.

According to a first advantageous variant, the compressed-air controller, when compressed air is to be discharged from the pressure consumer, activates the open operating mode by way of the compressed-air controller calculating or estimating in advance the expected reservoir pressure on the basis of the available information about reservoir pressure in the pressure reservoir and the volume of the pressure reservoir, the pressure in the compressed-air consumer or one or more of its components and their volumes and height level, and, when the calculated or estimated reservoir pressure exceeds a specified reservoir pressure limit value, activating the open operating mode. The compressor then remains switched off, the return flow valve and the reservoir valve remain closed (deactivated) and the outlet valve is opened (activated). Thus, the compressor is not switched on, the return flow valve and the reservoir valve stay in the closed position and only the outlet valve and the respective pressure consumer valves are opened.

The compressed-air controller preferably adaptively defines the reservoir pressure limit value from a correlation of counterpressure and current consumption learnt during operation of the compressor module.

### BRIEF DESCRIPTION OF DRAWINGS

The invention will now be described with reference to the drawings wherein:

FIG. 1 shows a circuit diagram of an example of a compressed-air supply system together with a compressed-air consumer in the form of air springs of a vehicle;

FIGS. 2A and 2B show symbols for the valves shown in FIG. 1 for explaining their manner of operation;

FIG. 3 shows a compressor module including a compressor, an electric motor and a motor controller;

FIG. 4 shows a sketch for illustrating the manner of operation of a brushless electric motor;

FIG. 5 shows graphs for illustrating the increase in the current consumption by an electric motor as the counterpressure increases;

FIG. 6 shows a symbolic representation of a compressor and a brushless electric motor driving it and including a motor controller; and,

FIGS. 7A and 7B show graphs for illustrating the effect of the switchover according to the disclosure from the closed operating mode (FIG. 7a) to the closed operating mode (FIG. 7b) on the current consumption by the electric motor driving the compressor.

### DETAILED DESCRIPTION

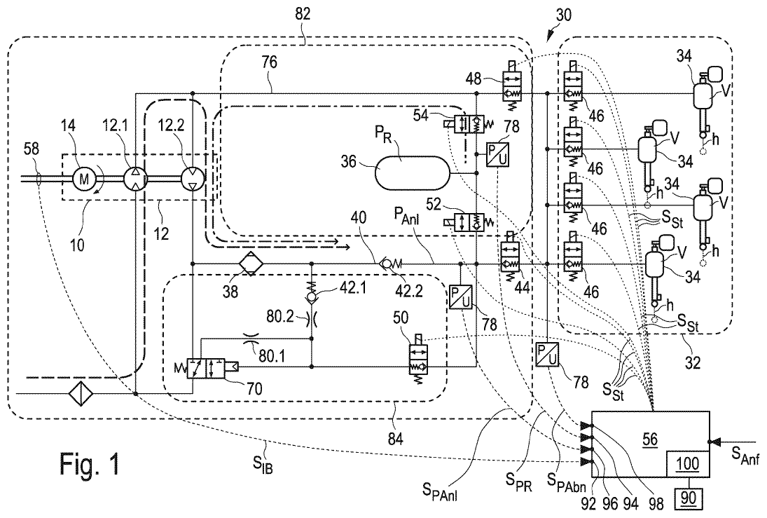

The compressed-air supply system 30 shown in FIG. 1 is used, for example, to supply compressed air to an air spring system 32 including a plurality of air springs 34 of a vehicle. Instead of an air spring system 32, other compressed-air consumers, for example a compressed-air brake system, can also be pneumatically connected to the compressed-air supply system 30.

The term “compressed-air consumer” is used herein both for an entire air spring system 32 or compressed-air brake system and for individual spring bellows 34 of an air spring system 32 or compressed-air brakes of a compressed-air brake system, thus for any form of compressed-air consumer.

Essential constituent parts of the compressed-air supply system 30 are a compressor 12 and its drive 14, compressed-air lines 22 and also electrically controllable valves 44, 46, 48, 50, 52 and 54 which can be controlled—that is, for example opened and closed—by a compressed-air controller 56. In this way, compressed air can be supplied to or discharged from the individual compressed-air consumers 34 in a targeted manner. The compressor work to be performed by the compressor 12 can differ greatly depending on which of the compressed-air consumers 34 has to be supplied with compressed air in the respective operating situation. The compressed-air controller 56 is an electronic controller which can output electrical signals for activation to the individual electrically controllable valves and thus control the compressed-air supply system 30. The compressed-air controller 56 is connected to or contains a memory 90 for operating specifications. In addition, the compressed air controller 56 has different signal inputs, for example a signal input 90 for a request signal S_{Anf}, a signal input 92 for a signal S_{IB} representing a motor current I_{B}, a signal input 94 for a signal S_{PAnl} representing an air pressure P_{Anl} prevailing in a main pressure line 42 of the compressed-air supply system 30, a signal input 96 for a signal S_{PR} representing an Panl_{Anl} prevailing in a pressure reservoir 36 of the compressed-air supply system 30, and a signal input 98 for a signal S_{PA}bn representing an air pressure P_{Abn} prevailing at a pressure consumer 34. A type of compressing device can also be provided instead of the compressor 12.

For increased efficiency and constant availability, so-called “closed air spring systems” are used in passenger car air spring systems. These are air spring systems which can be operated, for example, with a compressed-air supply system 30, as shown in FIG. 1, because the compressed-air supply system 30 has components such as a pressure reservoir 36 which, in addition to an open operating mode, also allow a closed operating mode. In contrast to the “open systems” or an open operating mode, in the closed operating mode a reduction in the air mass in the air springs does not take place by discharging the excess air into the surrounding area, but rather this air is pumped into the pressure reservoir 36 by using the compressor 12. The compressor 12 required for this purpose is preferably configured for two-stage compression and driven by a BLDC motor 14. The closed operating mode by way of recirculation takes place via the second stage 12.2; in the open operating mode, the compressor 12 operates in two stages by pre-compression via the first stage 12.1 and final compression via the second stage 12.2.

In order to allow a closed operating mode, the compressed-air supply system 30 in the exemplary embodiment shown also has, in addition to the pressure reservoir 36, a return flow valve 48, a reservoir valve 52, a separation valve 44 and a boost valve 54.

The return flow valve 48 is pneumatically arranged between the pressure consumer 32 and the compressor 12 in such a way that compressed air can flow from the compressed-air consumer 32 into a boost and return flow line 76, which leads to the compressor 12, through the return flow valve 48 when it is activated—that is, opened.

The reservoir valve 52 is pneumatically arranged between the pressure reservoir and a pneumatic main pressure line 40 in such a way that compressed air can flow from the pressure reservoir 36 into the pneumatic main pressure line 40 through the reservoir valve 52 when it is activated—that is, opened.

The boost valve 54 is pneumatically arranged between the pressure reservoir 36 and a boost and return flow line 76 in such a way that compressed air can flow from the pressure reservoir 36 into the boost and return flow line 76, which leads to the compressor 12, through the boost valve 54 when it is activated—that is, opened. Thus, the compressor 12 can recompress the compressed air removed from the pressure reservoir 36 during closed operation, before it is supplied to the compressed-air consumer 32.

The separation valve 44 is pneumatically arranged between the main pressure line 40 and the air spring system 32 in such a way that compressed air can flow from the main pressure line 40 into the air spring system 32 through the separation valve 32 when it is activated—that is, opened.

Due to the required compressor capacity or the delivery capacity derived therefrom, the required torques for the driving compressor 12 in the closed operating mode differ significantly from the torque required for the open operating mode.

As already indicated, the compressed-air supply system 30 shown in FIG. 1 can be operated in an open operating mode or in a closed operating mode. In the open operating mode, outside air is drawn in from the surrounding area and compressed (see the dashed arrow in FIG. 1), and in the closed operating mode, air is extracted from a pressure vessel 36—also referred to as a reservoir here—and compressed (see the dash-dotted arrow in FIG. 1).

If the current consumption by the drive of the compressor—that is, the current consumption by the electric motor 14—(which is proportional to the required torque) during open operation is below approx. 25 A, it can increase to 50 A or more during closed operation. The closed operating mode is therefore the operating mode with the highest torque or current requirement. Both operating modes have to be provided in one vehicle.

The following text first describes how compressed air can be fed to the compressed-air consumers 34, that is, the spring bellows 24 of an air spring system 32 of a vehicle for example. This is necessary, for example, if the vehicle is to be lifted on one side or on all sides. For this lifting operation, compressed air has to be supplied to the bellows 34.

### Open Operating Mode

Both the lifting and lowering operations can be performed in the closed operating mode in an air spring system.

In the first open operating mode, for example for lifting the air spring system 12, compressed air is passed from the compressor 12 to the compressed-air consumer 32 —that is, the air spring system 32—via a pneumatic main pressure line 40 for the compressed-air supply of the compressed-air consumer 32. Within the air spring system 32, the compressed air is distributed via individual pressure consumer valves 46—which are bellows valves 46 of spring bellows 34 of the air spring system 32 in the exemplary embodiment shown.

In the exemplary embodiment shown, the compressor 12 is configured in two stages and has a first stage 12.1 and a second stage 12.2. In the open operating mode, the outside air is thus, in two stages, first pre-compressed via the first compressor stage 12.1 and then re-compressed via the second compressor stage 12.2.

The compressed air provided in the open operating mode by the compressor 12 can also be supplied to a pressure reservoir 36 instead of a compressed-air consumer, in order to thus create the prerequisite for a closed operating mode.

Therefore, a compressor, such as compressor 12, and a pneumatic main pressure line 40, which feeds compressed air provided by the compressor 12 to the compressed-air consumer 32, are required for the compressed-air supply in the open operating mode. Further components, such as an air dryer 38 or an isolating or separation valve 44, are optional.

In the second open operating mode, for example when lowering the air spring system 12, the outlet valve is opened. This opening of the outlet valve 50 causes the pneumatically controlled 3/2-way valve 70 to be moved to the working position in which venting takes place. After opening the outlet valve 50, the pressure of the air to be vented acts as a control pressure, which acts on a control piston 74 of the pneumatically controlled 3/2-way valve 70 and moves the 3/2-way valve 70 against the force of its return spring 72 to the working position. Throttles 80.1 and 80.2 and also two non-return or one-way valves 42.1 and 42.2 provide expedient limiting of the control pressure for actuating the pneumatically controlled 3/2-way valve 70.

### Closed Operating Mode

Both the lifting and lowering operations can be performed in the closed operating mode in an air spring system. In general, this means that a compressed-air consumer can be supplied with compressed air in a first closed operating mode and can discharge air in a second closed operating mode—also referred to as the reflow mode.

For the closed operating mode, a pressure reservoir 36, for example configured as a compressed-air vessel, a reservoir valve 52, an optional boost valve 54 and a likewise optional separation valve 44 and a likewise optional return flow valve 48 and also corresponding compressed-air lines are additionally provided. The components for the closed operating mode, which are not required for the open operating mode, —namely the pressure reservoir 36, the reservoir valve 52, the optional boost valve 54 and the return valve 48—are shown in FIG. 1 within the dashed border 82.

In the first closed operating mode, for example for lifting an air spring system, air is pumped from the pressure reservoir 36 to the air spring system 32 and into its spring bellows 34 via the compressor 12 and its second compressor stage 12.2. For this purpose, the compressor 12, the boost valve 54 and the separation valve 44 are activated and the bellows valves 46 are opened. In this way, a vehicle can be lifted via the air spring system 32 in the closed operating mode of the compressed-air supply system 30 (“boost”). Since the air in the pressure vessel 36 is already at a higher static pressure than the outside air in the surrounding area, the air is, in the closed operating mode, re-compressed only via the second stage 12.2 of the compressor 12 and the first stage 12.1 of the compressor 12 is pneumatically ineffective in this case.

Just like in the open operating mode, the compressed air is, in the closed operating mode, also fed via the air dryer 38 of the pneumatic main pressure line 40 to and through the one-way or non-return valve 42.2 and thus provided for delivery to a compressed-air consumer 32.

In the second closed operating mode, for example when lowering an air spring system, air is pumped from the bellows 34 into the pressure reservoir 36. Here, the compressor 12 is activated and both the return flow valve 48 and the reservoir valve 52 are opened, that is, activated. Air is then pumped from the bellows 36, through the return flow valve 48, via the second stage 12.2 of the compressor 12, through the reservoir valve 52, into the pressure reservoir 36.

Distribution of Compressed Air within the Compressed-Air Consumer

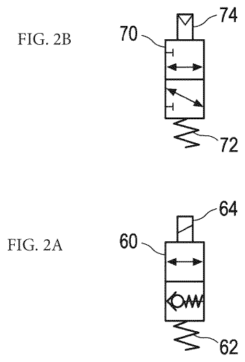

The delivery of the compressed air to the compressed-air consumer or consumers 32 or the pressure reservoir 36 and also the distribution of the compressed air within the compressed-air consumer 32—in the case of the example between the air springs 34 of the air spring system 32—is performed via electrically actuated 2/2-way valves 46, one of which is also shown in FIG. 2a as 2/2-way valve 60. In their first (rest) position caused via a return spring 62, the 2/2-way valves 46 act as a one-way or non-return valve. In the actuated second (activated or working) position, the 2/2-way valves 46 are opened. The electrically actuable 2/2-way valves 46 are connected to an electronic compressed-air controller 56, which can be identical to an electronic control unit for controlling the compressor module 10 and can actuate control solenoids 64 of the 2/2-way valves 46. The 2/2-way valves 46 of the compressed-air consumer 32—that is, in the case of the example the air spring system 32—correspond to the 2/2-way valve 60 shown in FIG. 2a.

### Venting

Irrespective of whether the compressed-air supply system 30 is operated in the open or closed operating mode, venting of one or more components—such as the spring bellows 34 for example—of the compressed-air consumer 32 may be necessary. In the case of a vehicle with an air spring system, one or more bellows 36 of the air spring system has to be vented if the vehicle is to be lowered on one side or on all sides.

The compressed-air consumer 32—for example when lowering the vehicle with an air spring system—can also be vented in the open or in the closed operating mode. These variants for venting of the compressed-air consumer 32 will be explained in more detail below. Both cases involve venting the compressed-air consumer 32—that is, not venting the compressed-air supply system 30 as a whole. The compressed-air supply system 30 is necessarily vented during open operation in which air is discharged from the compressed-air supply system 30 into the surrounding area.

### Venting During Open Operation

In the case of the example shown, the compressed-air supply system 30 is configured as an indirectly venting compressed-air supply system for venting in the open operating mode.

Here, an outlet valve 50, a pneumatically controlled 3/2-way valve 70, throttles 80.1 and 80.2 and also a further non-return or one-way valve 42.1 are provided for this purpose—see the corresponding border 84 around the components for indirect venting in FIG. 1.

Venting of the compressed-air supply system 30 and one or more compressed-air consumers 32 can be caused in the open operating mode by opening the outlet valve 50, which is also configured as an electrically actuated 2/2-way valve. Opening the outlet valve 50 causes the pneumatically controlled 3/2-way valve 70, as is also shown in FIG. 2b, to be moved to the working position. The working position is the position in which venting is performed. After opening the outlet valve 50, the pressure of the air to be vented acts as a control pressure, which acts on a control piston 74, which moves the 3/2-way valve 70 against the force of its return spring 72 to the working position. Throttles 80.1 and 80.2 and also two non-return or one-way valves 42.1 and 42.2 provide expedient limiting of the control pressure for actuating the pneumatically controlled 3/2-way valve 70.

### Venting During Closed Operation

In the closed operating mode, the components of the compressed-air consumer 32 are vented into the pressure vessel 36.

During venting in the closed operating mode, the air from the bellows 34 is pumped into the pressure reservoir 36 via the compressor 12 and its second compressor stage 12.2. For this purpose, the compressor 12 is activated and the return flow valve 48 and also the reservoir valve 52 are opened. Thus, for example, the air spring system 32 can be lowered in the closed operating mode. In this case, the first stage 12.1 of the compressor 12 is pneumatically ineffective.

### Combination of Open/Closed Operating Mode

An open operating mode exists when:
the compressor 12 delivers air directly from the surrounding area into the compressed-air consumers 34, for example the bellows 34 of the air spring system 32; then the compressor 12 is activated, the separation valve 44 is activated and the bellows valves 46 are activated=>“Lift” request the compressor 12 fills the compressed-air reservoir 36 from the surrounding area; then the compressor 12 is activated and the reservoir valve 52 is activated
=>“Fill reservoir” request
the air is vented from the compressed-air consumers 34 (in the example: the bellows 34 of the air spring system 32) into the atmosphere (bellows valves activated, separation valve activated, outlet valve activated)=>“Lower” request in the atmosphere.

A closed operating mode exists when:
the air from the bellows 34 is pumped into the pressure reservoir 36; then the compressor 12 is activated, the return flow valve 48 is activated, the reservoir valve 52 is activated=>“Lower” request in closed operating mode (“reflow”). In this case, the first stage 12.1 of the compressor 12 is pneumatically ineffective. The air is pumped from pressure reservoir 36 into bellows 34; then compressor 12 is activated, boost valve 54 is activated, the separation valve 44 is activated, the bellows valves 46 are activated=>“Lift” request in the closed operating mode (“boost”). In this case, the first stage 12.1 of the compressor 12 is pneumatically ineffective.

### The Compressor Module

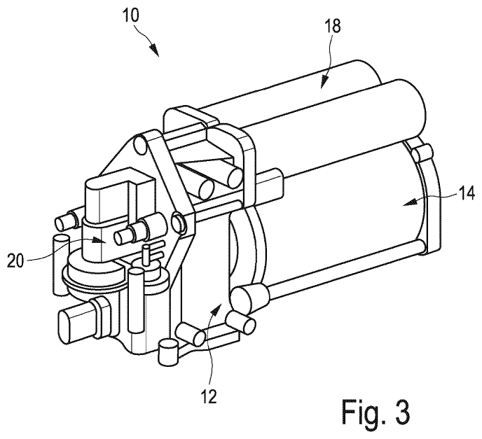

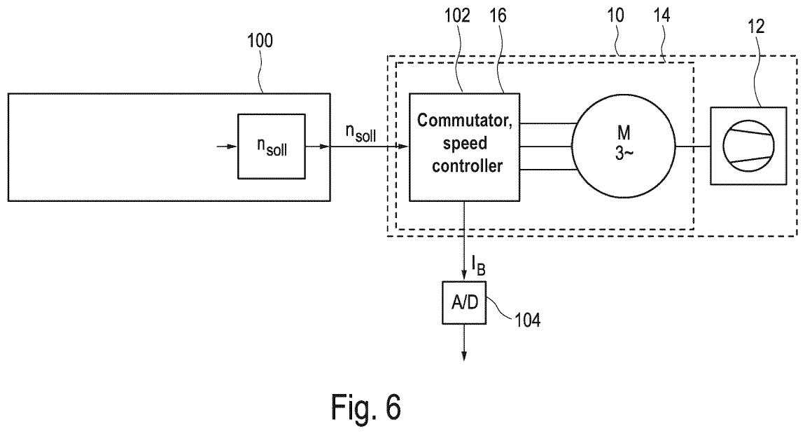

The compressor module 10 shown in FIG. 3 is provided for use in the compressed-air supply system 30, as illustrated by way of example in FIG. 1 with reference to a circuit diagram. The compressor module 10 is configured as a structural unit consisting of compressor 12, electric motor 14 and motor controller (16, see FIG. 6; not shown in FIG. 1; typically directly flange-connected to the electric motor 14) and also further components, such as air dryer 18 and air distributor 20 et cetera, for example.

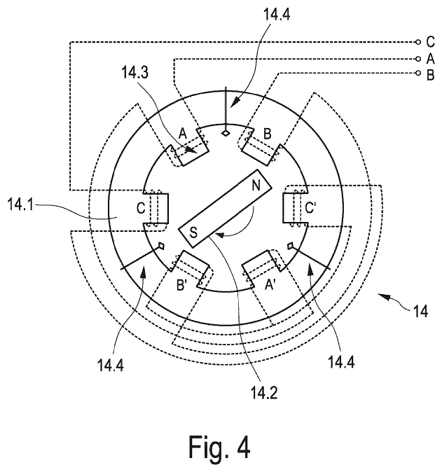

FIG. 4 shows a sketch of the stator and rotor of a brushless direct-current motor. The sketched brushless direct-current motor 14, as a so-called internal rotor motor, typically has a stator 14.1 fitted with electromagnetic coils—that is, a coil-wound stator, a rotor 14.2 fitted with permanent magnets, and an electronic motor controller 16 (see FIG. 6). The motor controller 16 is configured as an electronic commutator in such a way that the motor controller 16 controls the current supply to the coils 14.3 of the s 14.1 via circuit breakers and the connections A, B and C such that the coils 14.3 are in turn periodically supplied with current in such a way that a rotating magnetic field is produced, this causing synchronous rotation of the rotor 14.2 fitted with permanent magnets due to magnetic forces.

For speed control known per se of the brushless electric motor 14, the electric motor has means for rotor angle detection, for example a Hall sensor 14.4, for detecting the rotor position. This also allows a phase angle between the applied rotating field and the mechanical rotation of the rotor 14.2 to be detected and the phase angle of the rotating field to be correspondingly adjusted. The BLDC motor 14 therefore behaves similarly to a mechanically commutated direct-current motor. However, as a brushless direct-current motor, it is more efficient and subject to less wear and its speed can be controlled better than electric motors 14 with a brush commutator.

In order to generate the rotating field by periodically energizing the coils 14.3 via the terminals A, B and C, the motor controller 16 is provided, which acts as an electronic commutator; see FIG. 6.

The speed of the electric motor 14 is also controlled in a manner known per se via the motor controller 16. For this purpose, a target speed is specified for the motor controller 16. In order to specify the target speed, an electronic control unit 100 is provided, which is supplied a value for the mean motor current by the motor controller 16 or which is connected to a current sensor 58, 102, which detects the respective motor current drawn by the electric motor 14 during operation.

The current consumption by the electric motor 14 can be both calculated from the measured phase currents by the motor controller 16 and directly measured via the current sensor 58 or 102. In the first case, three current sensors 102 are required, which are necessary for operational safety in any case. In the second case, an extra current sensor 58 is necessary in the supply branch (see FIG. 1). The variant without a separate current sensor 58 is therefore preferred.

Compared to an unregulated direct-current motor, controlled, brushless direct-current motors have the advantage that their speed can be continuously controlled without any additional design effort. The brushless direct-current motor is commutated electronically, while a direct-current motor with a brush consumer system commutates mechanically.

For acoustic reasons, air spring systems require a constant speed over the entire specified load range (voltage, counterpressure and boost pressure, temperature, geodetic height), this endorsing the use of a controlled direct-current motor.

A disadvantage of the speed specification is that the request n=const results in a motor current which increases with the torque and which can also exceed the defined maximum limit of, for example, 35 A in the specific case. In order to maintain the maximum permissible current consumption, the compressing device would have to be configured in such a way that the current consumption is never exceeded under worst-case operating conditions within the specified applications. Such a scenario may be, for example, a laden vehicle, with twisted axles on rough terrain.

The disclosure now proposes configuring the motor for a constant speed as standard and reducing the necessary drive power of the compressing device when the permissible current consumption (usually 35 A) is exceeded. For this purpose, the current consumption of current by the compressing device is determined, and when the defined limit value is exceeded closed operation of the compressing device is terminated and control is completed in the open operating mode.

Mode switchover based on the mean motor current has the advantage of the assembly-specific tolerances, the different pressure ranges and other values that influence the current consumption by the electric motor—that is, the motor current—not having to be stored in the form of worst-case assumptions, but rather being detected in an assembly-specific manner and the performance of the compressor being maximized in all operating ranges.

The pneumatic performance of a compressing device for an air spring system is usually configured for the most common operating point. For example, a volume flow rate of 130 l/min is required at 11 bar boost pressure and 11 bar counterpressure. The maximum current consumption of 35 A, however, applies in all working ranges (operating and ambient pressures, voltages).

In order not to design the electric motor to be too large, it is configured for a current consumption of approx. 30 A at the specified operating point (taking into account device variations, service life influences, slightly higher operating loads). Particularly during pressure-charged operation, there is a sharp increase in the necessary drive power or the necessary current beyond 35 A (current˜torque) as the counterpressure increases.

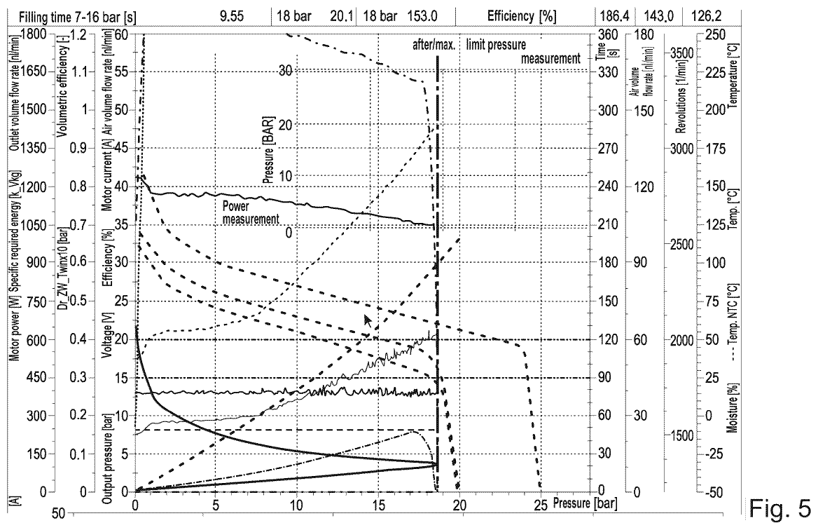

In the example shown in FIG. 5, the current increases by more than 2 A per bar of counterpressure. A remedy would be to design the compressor module 10 in such a way that no excess currents occur at the defined, rather rare worst-case operating points. However, this has the disadvantage that the compressor module 10 exhibits correspondingly reduced, non-specification-compliant performance in the common operating ranges. A required delivery capacity of, for example, 130 I/min at 11 bar pre-pressure and 11 bar counterpressure cannot be achieved in this case. The problem is exacerbated by the device variation and service life influences. In order to avoid high currents, the speed of the BLDC motor can be reduced. Due to the proportionality of speed and current, however, this can result in an excessive, necessary speed reduction. If, for example, the current consumption is to be reduced from 60 A to 35 A, the speed would have to be reduced to 58% of the original speed, from for example 2850 min⁻¹ to below 1700 min⁻¹. This significant reduction in speed can lead to undesired effects in airborne and structure-borne noise.

One approach is to operate the BLDC motor at a constant speed and, in order to avoid overdimensioning the direct-current motor, to reduce this speed under certain load conditions (operating voltage and load). If the design is correct and all nominal conditions are correctly taken into account, the maximum current of, for example, 35 A is not exceeded. However, this requires all current-influencing factors, such as component tolerances, operating temperatures in the form of worst-case assumptions, to be taken into account and the resulting early switchover to a lower speed (including the resulting performance reduction) to be acceptable.

The aim was therefore not to configuration the compressor module for the rare worst-case conditions, but instead to provide a configuration in line with the most common operating conditions in combination with current limiting to ensure the specified current limits in combination with the situationally maximum compressor performance.

The requirement for constant compressor speed leads to an increasing current consumption as the compressor drive torque (which is proportional to the necessary motor torque) increases:

$$Formula : M \times 2 π \times n = η \times U \times I$$

$$where :$$

$$M = compressor drive torque ( is constant at constant pressure )$$

$$n = compressor speed ( is kept constant in line with conventional control strategy in BLDC )$$

$$η = efficiency$$

$$U = supply voltage ( specified , between 9 V and 16 V as required )$$

$$I = motor current ( usually limited to 35 A )$$

Measurements have shown that the motor current consumption by a pressure-charged compressor for use in passenger car air spring systems can increase by more than 2 A/bar counterpressure. Therefore, when configured for the nominal point of 11 bar boost pressure and 11 bar counterpressure at I=30 A, only a counterpressure of up to 13.5 bar would be permissible (this then no longer covering the entire required operating range up to, for example, 18 bar). Further reductions may result from:
manufacturing-related device variation
running-in effects
wear
environmental conditions
self-heating

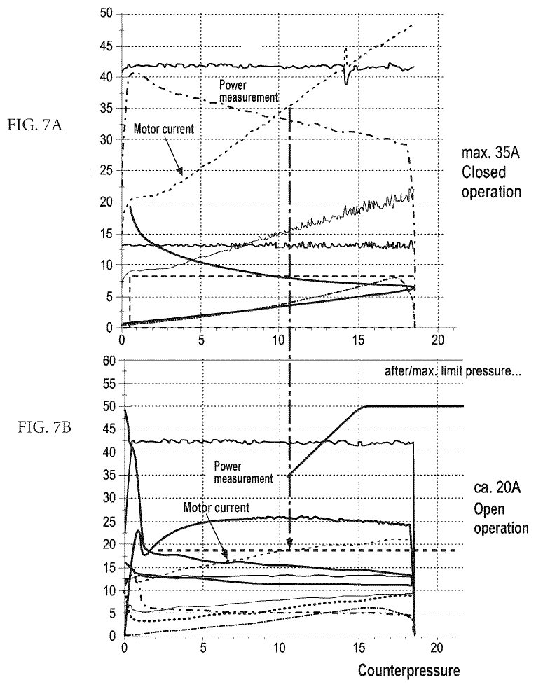

For switchover according to the disclosure from the closed to the open operating mode when a specified maximum motor current is reached or exceeded, the current consumption by the drive motor 14 for the compressor 12 is permanently determined. As soon as the current consumption (that is, the motor current) exceeds the specified limit value for a certain time, the torque requirement of the compressor is reduced by switching over to open operation. In the example shown, the motor current reaches the current limit value of 35 A at a counterpressure of approx. 11 bar during pressure-charged operation. If the compressed-air supply system 30 were to continue operating with the closed manner of operation, the to the electric motor 14 for driving the compressor 12 would draw a motor current of 48 A. By switching over to the open operating mode, however, the current consumption by the electric motor 14 drops to approx. 19 A, but of course with a correspondingly reduced volume flow rate. This is illustrated in FIG. 7.

The compressor module 10 is advantageously configured such that it can meet the majority of conditions of use without mode switchover. Only worst-case operating conditions, such as maximum loading plus maximum height or high axle articulation, should lead to corresponding switchover to open operation.

Furthermore, the basic configuration of compressor 12 and the associated electric motor 14—that is, compressor module 10—should not be geared toward worst-case tolerance positions et cetera, when using the disclosure, but rather should also take place here in accordance with the nominal values.

Advantages arise in the event that the nominal widths on the compressor pressure side are temporarily too small (for example in the case of delivery in only one bellows 34) and an excessively high counterpressure builds up due to the high delivery volume flow rate, which would then in turn lead to an excessively high motor current.

The application of the switchover according to the disclosure from a closed to an open operating mode is not limited to compressors which are driven by a BLDC direct-current motor (even if the latter are preferred), but can also be extended to compressors with other direct-current motors.

In the case of the example, the switchover from closed to open operation is performed as described below.

The switchover from lifting via boosting (that is, from the closed operating mode) to lifting in the open operating mode is performed in a very simple manner by switching off (deactivating and thus closing) the boost valve 54.

In the case of reflow-lowering activities (that is, during venting in the closed operating mode, for example for lowering the vehicle), the switchover to the open operating mode is somewhat more complex since the compressor 12 has to be switched off, the return flow valve 48 and the reservoir valve 52 have to be closed and the outlet valve 50 has to be opened. Therefore, predictive control, as explained below, is advantageous here.

For the predictive control, it is not (only) the motor current that is determined, but also the pressure P on the pressure side of the compressor 12 or in the pressure reservoir 36. For this purpose, at least one P/U converter is provided as the pressure sensor 78. This can be provided, for example, on the main pressure line 40 or the pressure reservoir 36 or at both locations and also at other locations, depending on which pressure is to be detected, for example, for predictive control.

The accuracy of the prediction of the motor current I_{B, prä} and thus the decision as to whether, for example, lowering takes place in the open or closed operating mode can be improved over the following cases 1 to 3 by increasing forecasting complexity.

Since the motor current is proportional to the drive torque respectively required by the compressor (torque requirement), the open operating mode or the closed operating mode and/or a suitable target speed can also be selected by predictive control entirely without taking into account the motor current itself but rather solely on the basis of the influencing variables influencing the torque requirement of the compressor at a given speed and their foreseeable temporal development—for example the counterpressure which increases as the pressure reservoir fills up. This—the predictive selection of the open or closed operating mode and the corresponding actuation of the compressed-air supply system—represents an independent inventive concept, which can be realized both in combination with the mode switchover described here on the basis of the motor current and also independently of the motor current.

In the simplest case 1, the compressed-air controller is configured, in response to a “Lower” request, to activate either the closed operating mode or the open operating mode solely depending on the current reservoir pressure (that is, the air pressure in the pressure reservoir). If the current reservoir pressure is too close to a maximum permissible reservoir pressure limit value, so that not enough air mass can be additionally stored in the pressure reservoir in order to be able to discharge enough air from the air consumer (that is, for example, to lower the vehicle far enough), then open operation is selected from the beginning, in order to avoid switchover the operating mode during the lowering operation. For this purpose, the compressed-air controller is configured, amongst other things, as a pressure estimator.

In the second case, the compressed-air controller is configured to calculate the established (that is, expected) reservoir pressure in advance (air mass manager) or to estimate it in the event of an incomplete data situation (air mass estimator) on the basis of the available information about reservoir pressure and volume, bellows pressure, bellows geometry and height level and also the requested control (for example lifting or lowering). If the calculated or estimated reservoir pressure exceeds a specified or learnt reservoir pressure limit value, the lowering process is carried out from the outset via bellows venting into the atmosphere, that is, in the open operating mode. A switchover does not take place during the lowering operation.

In a third, advantageous embodiment, the compressed-air controller is configured to adaptively define a pressure limit value from case 2, but also from case 1, from a correlation of counterpressure and current consumption learnt during operation of the compressor module 10. Here, the inevitable device tolerances are compensated for in such a way that the switchover is performed in the form of self-calibration for compressors individually.

It is understood that the foregoing description is that of the preferred embodiments of the invention and that various changes and modifications may be made thereto without departing from the spirit and scope of the invention as defined in the appended claims.

### LIST OF REFERENCE NUMERALS

10 Compressor module
12 Compressor
12.1 First compressor stage
12.2 Second compressor stage
14 Electric motor
14.1 Stator
14.2 Rotor
14.3 Coil
14.4 Hall sensor
16 Electronic motor controller (motor electronics system)
18 Air dryer
20 Air distributor
22 Compressed-air line (general)
30 Compressed-air supply system
32 Air spring system
34 Bellows of the air springs
36 Pressure reservoir
38 Air dryer
40 Main pressure line (special compressed-air line)
42 One-way valve/non-return valve
44 Separation valve (electrically controlled)
46 Pressure consumer valve (bellows valve, electrically controlled)
48 Return flow valve (electrically controlled)
50 Outlet valve (exhaust valve, electrically controlled)
52 Reservoir valve (electrically controlled)
54 Boost valve (electrically controlled)
56 Compressed-air controller
58 Current sensor
60 2/2-way valve (electrically controlled)
62 Return spring
64 Control magnet
70 3/2-way valve (pneumatically controlled) for indirect venting
72 Return spring
74 Control piston
76 Boost and return flow line
78 Pressure sensor; P/U converter
80 Throttle
82 Components for closed operation
84 Components for indirect venting
90 Memory for operating specifications
92 Current signal input
94 Pressure signal input for a signal representing the pressure in the pressure reservoir 36
96 Pressure signal input for a signal representing the pressure of the compressed air in the main pressure line of the compressed-air supply system
98 Pressure signal input for a signal representing the pressure of the compressed air at the compressed-air consumer
100 Electronic control unit
P_{Abn} Pressure of the compressed air at the compressed-air consumer
S_{PAbn} Signal representing the pressure of the compressed air at the compressed-air consumer
P_{Anl} Pressure of the compressed air in the main pressure line of the compressed-air supply system
S_{PAnl} Signal representing the pressure of the compressed air in the main pressure line of the compressed-air supply system
P_{R} Pressure of the compressed air in the pressure reservoir
P_{R grenz} Reservoir pressure limit value, limit value for the pressure of the compressed air in the
pressure reservoir
P_{R gesch} Estimated pressure of the compressed air in the pressure reservoir
S_{PR} Signal representing the pressure of the compressed air in the pressure reservoir
nₛₒₗₗ Target speed (operating specification)
I_{B} Signal representing the motor current
S_{IB} Motor current
S_{Anf} Request signal
V Volume of a compressed-air consumer, in particular an air spring
H Height level of a compressed-air consumer, in particular an air spring

1. A compressed-air supply system comprising:
at least one compressed-air consumer;
a plurality of compressed-air lines;
a plurality of electrically controllable valves;
a compressed-air controller for actuating the electrically controllable valves;
a compressor having an electric motor as a drive;
a pressure reservoir;
said at least one compressed-air consumer is or is configured to be pneumatically connected to at least one of said compressor and said pressure reservoir via said plurality of compressed-air lines and said electrically controllable valves such that the compressed-air supply system is operable either in an open operating mode or in a closed operating mode; and,
said compressed-air controller having a current signal input for a current signal, which represents a motor current drawn or to be drawn by said electric motor driving said compressor, wherein said compressed-air controller is configured to actuate said plurality of electrically controllable valves in accordance with the open operating mode of the compressed-air supply system when the current signal is present at said current signal input, the current signal representing a mean motor current, a magnitude of which is equal to or greater than a specified maximum value for the motor current.

2. The compressed-air supply system of claim 1, wherein said current signal input is connected to at least one current sensor configured to detect the motor current drawn by said electric motor driving said compressor and to output a signal representative of the motor current to said compressed-air controller.

3. The compressed-air supply system of claim 1, wherein said at least one compressed-air consumer is an air spring system with at least one bellows.

4. The compressed-air supply system of claim 1, wherein said compressor is combined with said electric motor to form one structural unit.

5. The compressed-air supply system of claim 1, wherein said electric motor is a speed-controlled BLDC motor and at least one target speed is specified.

6. The compressed-air supply system of claim 1, wherein said compressed-air controller is configured to predictively determine the motor current to be drawn by said electric motor on a basis of an air pressure in the compressed-air supply system and a request to said at least one compressed-air consumer and to cause a switchover to the open operation when the predictively determined motor current reaches or exceeds the specified maximum value for the motor current.

7. The compressed-air supply system of claim 6 further comprising a pressure sensor arranged and configured such that, during operation, it detects an air pressure prevailing in the compressed-air supply system and outputs a pressure signal representing the air pressure prevailing in the compressed-air supply system to said compressed-air controller.

8. The compressed-air supply system of claim 6, wherein the request is a lower request.

9. The compressed-air supply system of claim 1 further comprising a reservoir valve pneumatically arranged between said pressure reservoir and a pneumatic main pressure line.

10. The compressed-air supply system of claim 9 further comprising a boost valve pneumatically arranged between said pressure reservoir and a boost and return flow line.

11. The compressed-air supply system of claim 1, wherein the compressed-air supply system is for a motor vehicle.

12. A method for operating a compressed-air supply system including at least one compressed-air consumer, a plurality of compressed-air lines, a plurality of electrically controllable valves, a compressed-air controller for actuating the electrically controllable valves, a compressor having an electric motor as a drive, and a pressure reservoir, wherein the at least one compressed-air consumer is or is configured to be pneumatically connected to at least one of the compressor and the pressure reservoir via the plurality of compressed-air lines and the plurality of electrically controllable valves such that the compressed-air supply system is operable either in an open operating mode or in a closed operating mode, the method comprising:
supplying a current signal, which represents a motor current drawn or to be drawn by the electric motor driving the compressor to the compressed-air controller during operation; and,
switching over the compressed-air supply system from the closed to the open operating mode via the compressed-air controller and actuating the electrically controllable valves in accordance with the open operating mode of the compressed-air supply system via the compressed-air controller when the current signal is present at a current signal input, the current signal representing a mean motor current, the magnitude of which is equal to or greater than a specified maximum value for the motor current.

13. The method of claim 12, wherein the compressed-air supply system has a boost valve which is pneumatically connected to the pressure reservoir; and, wherein said switching over from the closed operating mode to the open operating mode is performed when compressed air is fed to the at least one compressed-air consumer by deactivating the boost valve.

14. The method of claim 12, wherein the compressed-air supply system has an outlet valve, a return flow valve, and a reservoir valve, which is pneumatically connected to the pressure reservoir; said switching over from the closed operating mode to the open operating mode is performed when compressed air is discharged from the at least one compressed-air consumer by switching off the compressor, closing the return flow valve and the reservoir valve and opening the outlet valve.

15. The method of claim 12, wherein the compressed-air supply system has a pressure sensor at the pressure reservoir and an outlet valve, a return flow valve, and a reservoir valve, which is pneumatically connected to the pressure reservoir; when compressed air is to be discharged from the at least one compressed-air consumer, the compressed-air controller activates the closed operating mode if a current reservoir pressure in the pressure reservoir is less than a reservoir pressure limit value or activates the open operating mode if the current reservoir pressure in the pressure reservoir is equal to or greater than the reservoir pressure limit value.

16. The method of claim 12, wherein the compressed-air supply system has a pressure sensor at the pressure reservoir and an outlet valve, a return flow valve, and a reservoir valve, which is pneumatically connected to the pressure reservoir; the compressed-air controller, when compressed air is to be discharged from the at least one compressed-air consumer, is configured to calculate or estimate in advance an expected reservoir pressure on a basis of available information about reservoir pressure in the pressure reservoir and a volume of the pressure reservoir, a pressure in the at least one compressed-air consumer or one or more components of the at least one compressed-air consumer and their volumes and height level, and, when the calculated or estimated reservoir pressure exceeds a specified reservoir pressure limit value, is configured to activate the open operating mode by way of the compressor being switched off, the return flow valve and the reservoir valve being closed and the outlet valve being opened.

17. The method of claim 15, wherein the compressed-air controller adaptively defines the reservoir pressure limit value from a correlation of counterpressure and current consumption learned during operation of the compressor.

18. The method of claim 12, wherein the compressed-air supply system is for a motor vehicle.
